(19) United States
(12) Patent Application Publication
(10) Pub. No.: US 2013/0112782 A1
(43) Pub. Date: May 9, 2013

(54) INJECTION ASSEMBLY

(71) Applicant: Raymond Weiping Zhang, Brampton (CA)

(72) Inventor: Raymond Weiping Zhang, Brampton (CA)

(73) Assignee: HUSKY INJECTION MOLDING SYSTEMS LTD., Bolton (CA)

(21) Appl. No.: 13/810,541

(22) PCT Filed: Jun. 9, 2011
(86) PCT No.: PCT/CA11/50352

§ 371 Date: Jan. 16, 2013

Related U.S. Application Data
(60) Provisional application No. 61/367,506, filed on Jul. 26, 2010.

(51) Int. Cl. B29C 45/20

(52) U.S. Cl. CPC B29C 45/20
USPC 239/584

(57) ABSTRACT

An injection unit (24), comprising: a transfer piston assembly (34); and an injection piston assembly (30) being positioned coaxial with the transfer piston assembly (34).

### TECHNICAL FIELD

Examples of the present invention generally relate to (by way of example, but is not limited to) an injection unit, an injection assembly, and/or an injection molding system.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' invention so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process.

Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The total clamp force needed is determined by the projected area of the part being molded. This projected area is multiplied by a clamp force of from two to eight tons for each square inch of the projected areas. As a rule of thumb, four or five tons per square inch can be used for most products. If the plastic material is very stiff, it will require more injection pressure to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

Molding is a process by virtue of which a molded article can be formed from molding material (such as Polyethylene Teraphalate (PET), Polypropylene (PP) and the like) by using a molding system. Molding process (such as injection molding process) is used to produce various molded articles. One example of a molded article that can be formed, for example, from PET material is a preform that is capable of being subsequently blown into a beverage container, such as, a bottle and the like.

A typical injection molding system includes inter alia an injection unit, a clamp assembly and a mold assembly. The injection unit can be of a reciprocating screw type or of a two-stage type. Within the reciprocating screw type injection unit, raw material (such as PET pellets and the like) is fed through a hopper, which in turn feeds an inlet end of a plasticizing screw. The plasticizing screw is encapsulated in a barrel, which is heated by barrel heaters. Helical (or other) flights of the screw convey the raw material along an operational axis of the screw. Typically, a root diameter of the screw is progressively increased along the operational axis of the screw in a direction away from the inlet end.

As the raw material is being conveyed along the screw, it is sheared between the flights of the screw, the screw root and the inner surface of the barrel. The raw material is also subjected to some heat emitted by the barrel heaters and conducted through the barrel. As the shear level increases in line with the increasing root diameter, the raw material, gradually, turns into substantially homogenous melt. When a desired amount of the melt is accumulated in a space at discharge end of the screw (which is an opposite extreme of the screw vis-à-vis the inlet end), the screw is then forced forward (in a direction away from the inlet end thereof), forcing the desired amount of the melt into one or more molding cavities. Accordingly, it can be said that the screw performs two functions in the reciprocating type injection unit, namely (i) plasticizing of the raw material into a substantially homogeneous melt and (ii) injecting the substantially homogeneous melt into one or more molding cavities.

A two stage injection unit can be said to be substantially similar to the reciprocating type injection unit, other than the plasticizing and injection functions are separated. More specifically, an extruder screw, located in an extruder barrel, performs the plasticizing functions. Once a desired amount of the melt is accumulated, it is transferred into a shooting pot, which is also sometimes referred in the industry as a “shooting pot”, the shooting pot being equipped with an injection plunger, which performs the injection function.

U.S. Pat. No. 4,256,689 to Gardner (Mar. 17, 1981) discloses a method and apparatus for injection molding of thermoplastic materials in which a screw in a plasticizer acts as an injection ram to inject plasticized material through a heated runner system into a mold.

U.S. Pat. No. 5,454,995 to Rusconi and Reinhart (Oct. 3, 1995) discloses a method for reducing cycle time in injection molding machines that are running large capacity molds, such as multiple cavity preform molds, and require a high volume supply of quality melt.

U.S. Pat. No. 7,172,407 to Zimmet (Feb. 6, 2007) discloses an injection unit for an injection molding machine that includes a plasticizing unit in the form of an extruder, a plunger-type injection device, which can be connected to the injection molding machine by an injection nozzle.

US Patent Application Number 2001/0048170 to Wobbe et al. discloses an apparatus for producing thermoplastic injection-molded parts reinforced with long fibers, including a compounder having two meshing screws rotating in a same direction for continuously generating a stream of melt of thermoplastic material reinforced with long fibers.

US Patent Application Number 2005/0013896 to Dray discloses an injection molding apparatus for injecting resin into a mold, which includes an injection cylinder in fluid communication with the mold, wherein movement of a piston relative to the cylinder injects a selected quantity of resin into the mold.

PCT Publication Number WO2008/055339 to Ujma et al (May 15, 2008) discloses an active decompression to prevent melt drool from a mold or a runner system which is achieved through the selective coupling and de-coupling of an injection piston to a plunger.

### SUMMARY

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of the instant patent application. According to an aspect, there is provided an injection unit, comprising: a transfer piston assembly; and an injection piston assembly being positioned coaxial with the transfer piston assembly.

### DESCRIPTION OF THE DRAWINGS

A better understanding of the non-limiting embodiments (examples) of the present invention (including alternatives and/or variations thereof) may be obtained with reference to the detailed description of the non-limiting embodiments along with the following drawings, in which:

FIG. 1, 4, 5, 6, 7, 9, 10, 11 show examples of a cross-sectional view of an injection assembly;

FIG. 2 shows a flowchart illustrated the phases of an injection cycle for the injection assembly of FIG. 1;

FIGS. 3A-3C show cross-sectional views of the injection assembly of FIG. 1 in accordance with the phases illustrated in FIG. 2;

FIG. 7 shows a flowchart illustrated the phases of an injection cycle for the injection assembly of FIG. 6; and

FIGS. 8A-8C show cross-sectional views of the injection assembly of FIG. 6 in accordance with the phases illustrated in FIG. 7;

### DETAILED DESCRIPTION

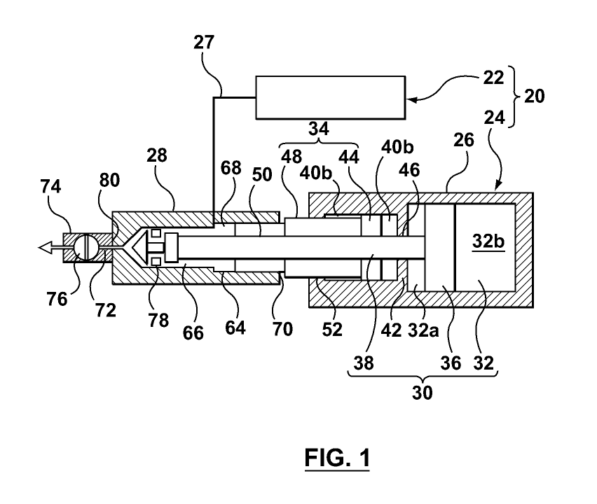

Referring now to FIG. 1, an injection assembly 20 for an injection molding system. Injection assembly 20 includes an extruder unit 22 and an injection unit 24. Extruder unit 22 is adapted to receive non-melted resin and plasticize it into a melt suitable for injection into the mold (not depicted but known). The implementation of extruder unit 22 is not particularly limited and can include both single-screw extruders and twin-screw extruders. The extruder unit 22 can be of a reciprocating type (typically used in single-screw extruders) or a non-reciprocating type (typically used in twin-screw extruders). In the presently-illustrated embodiment, extruder unit 22 is a twin-screw, continuous extruder, that is to say, that extruder unit 22 runs continuously through each molding cycle. Alternatively, extruder unit 22 may be adapted to run non-continuously so that it pauses during portions (such as the injection phase for example) of the molding cycle.

The extruder unit 22 is in communication with the injection unit 24 via a transfer channel 27 so that the plasticized melt is transferred from the extruder unit 22 to the injection unit 24. In the presently-illustrated embodiment, injection unit 24 includes a piston housing 26 and plunger housing 28, the two being spaced apart to reduce heat transference between the plunger housing 28 and the piston housing 26. Alternatively, the two housings may also abut against each other. As will be described in more detail below, the plunger housing 28 is adapted to receive and store the melt from extruder unit 22 (via transfer channel 27). The piston housing 26 is adapted to actuate an injection piston 36 to transfer the received melt within the plunger housing 28, and is further adapted to actuate a transfer piston 44 to subsequently transfer the melt out of the plunger housing 28 towards a mold (not shown). As shown, the piston housing 26 and plunger housing 28 are coaxially aligned with each other along a common axis of injection unit 24. In a typical configuration, the piston housing 26 and plunger housing 28 share a common mounting base or frame (not shown) to help provide the correct spacing and alignment of the two housings.

Piston housing 26 can be defined by an integrally-formed structure, or by multiple substructures assembled together. The piston housing 26 is adapted retain an injection piston assembly 30 and a transfer piston assembly 34. As currently-illustrated, the injection piston assembly 30 and the transfer piston assembly 34 are coaxially arranged with each other along the common axis of the injection unit 24. That is, the injection piston assembly 30 is positioned coaxial with the transfer piston assembly 34. The meaning of coaxial is: having a common axis; two or more forms or structures that share a common axis.

Injection piston assembly 30 includes a piston chamber 32, which is defined within piston housing 26. Slidably located within piston chamber 32 is an injection piston 36. An injection plunger 38 extends from injection piston 36 into the plunger housing 28. An oil port (not shown) is provided on the rod side 32a of piston chamber 32, and another oil port (also not shown) is provided on the cylinder side 32b of piston chamber 32. By selectively filling and draining the rod side 32a and cylinder side 32b with hydraulic fluid through the oil ports, injection piston 36 is operable to translate between a forward position and a rearward position. The distance between the forward position and the rearward position defines a maximum “injection stroke” of injection plunger 38.

Transfer piston assembly 34 includes a transfer piston chamber 40, which is defined by piston housing 26. A wall 42 separates the transfer piston chamber 40 from the piston chamber 32. A rod aperture 46 is defined within wall 42 so that injection plunger 38 can extend from piston chamber 32 through transfer piston chamber 40. Wall 42 contains fluid-tight seals (not shown) so that each of piston chamber 32 and transfer piston chamber 40 can be pressurized separately.

Slidably located within the transfer piston chamber 40 is a transfer piston 44. An oil port (not shown) is provided on the rod side 40a of transfer piston chamber 40, and another oil port (also not shown) is provided on the cylinder side 40b of transfer piston chamber 40. By selectively filling and draining the rod side 40a and cylinder side 40b with hydraulic fluid through the oil ports, transfer piston 44 is operable to translate between a forward position and a rearward position independent of the position or movement of injection piston assembly 30.

Transfer piston assembly 34 further includes a transfer plunger 48. A rod aperture 50 is defined within both transfer piston 44 and transfer plunger 48, through which extends injection plunger 38. Rod aperture 50 is sized so that the transfer piston 44/transfer plunger 48 are operable to translate freely relative to the position or movement of injection plunger 38. However, the transfer plunger 48 is motivated in a forwards direction by transfer piston 44 towards the mold (not shown), and rearwards by the melt pressure within plunger housing 28. During operations of injection unit 24, as the transfer piston 44 is stroked forward, and after a period of lost motion, the transfer piston 44 comes into contact with transfer plunger 48, motivating the transfer plunger 48 towards its forward position.

A rod aperture 52 is provided in piston housing 26 on the side facing the plunger housing 28. Rod aperture 52 is sized so that transfer plunger 48 (and the injection plunger 38 located there within) extends out from the transfer piston chamber 40 and into plunger housing 28.

Plunger housing 28 defines an interior void that is divided into a transfer pot 64 and an injection pot 66. The transfer pot 64 is configured to receive the melt from the extruder unit 22. The transfer pot 64 and the injection pot 66 are in communication with each other. The injection pot 66 is in communication with the transfer pot 64. The transfer pot 64 has a larger diameter than injection pot 66, with a land 68 being provided between transfer pot 64 and injection pot 66. In the presently-illustrated embodiment, the transfer pot 64 and the injection pot 66 have generally the same volume. Transfer volume may be slight smaller or larger than the injection volume because the extruder also feeds some melt during the transfer.

As will be described in greater detail below, the transfer pot 64 is used to store the melt received from extruder unit 22 and the injection pot 66 is used to store the melt received from the transfer pot 64 prior to injection into a mold (not shown). In the presently-illustrated example, the transfer pot 64 and the injection pot 66 are coaxially-aligned with each other (and with the injection piston assembly 30 and the transfer piston assembly 34) along the common axis. The transfer piston assembly 34 is configured to transfer, in use, the melt from the transfer pot 64 to the injection pot 66. The injection piston assembly 30 is configured to transfer the melt from the injection pot 66 out from the injection unit 24 towards the mold. The transfer pot 64 is operable to receive the melt from the extruder unit 22 while the injection piston assembly 30 is operable to transfer the melt out from the injection unit 24 towards the mold. The meaning of “while” is: during the time that; at the same time that; at the same time (more or less) at least in part.

Plunger housing 28 defines a rod aperture 70 at a first end, though which extends both injection plunger 38 and transfer plunger 48. The plunger housing 28 contains fluid-tight seals (not shown) around rod aperture 70 so that a fluid-tight seal is provided around transfer piston 44. Plunger housing 28 further defines an outlet 80 at a second end which is in communication with an outlet channel 72 defined within a nozzle 74. A shut-off valve 76 is located within nozzle 74, and is operable to move between an open and a closed position.

The injection plunger 38 terminates within injection pot 66. A non-return valve 78 is located at the distal end of injection plunger 38. Non-return valve 78 is actuated between an open and a closed position through the movement of the injection piston 36 between its forward and rearward positions. (Melt pressure within transfer pot 64 can also open the non-return valve 78). In the presently-illustrated example, non-return valve 78 is a check valve and is configured so that moving the injection piston 36 towards its forward position closes the non-return valve 78 and moving the injection piston 36 towards its rearward position opens non-return valve 78. The transfer plunger 48 terminates within transfer pot 64, as the forward position of transfer plunger 48 is limited by land 68. Non-return valve 78 also prevents melt leaking back into the transfer pot 64 from the injection pot 66.

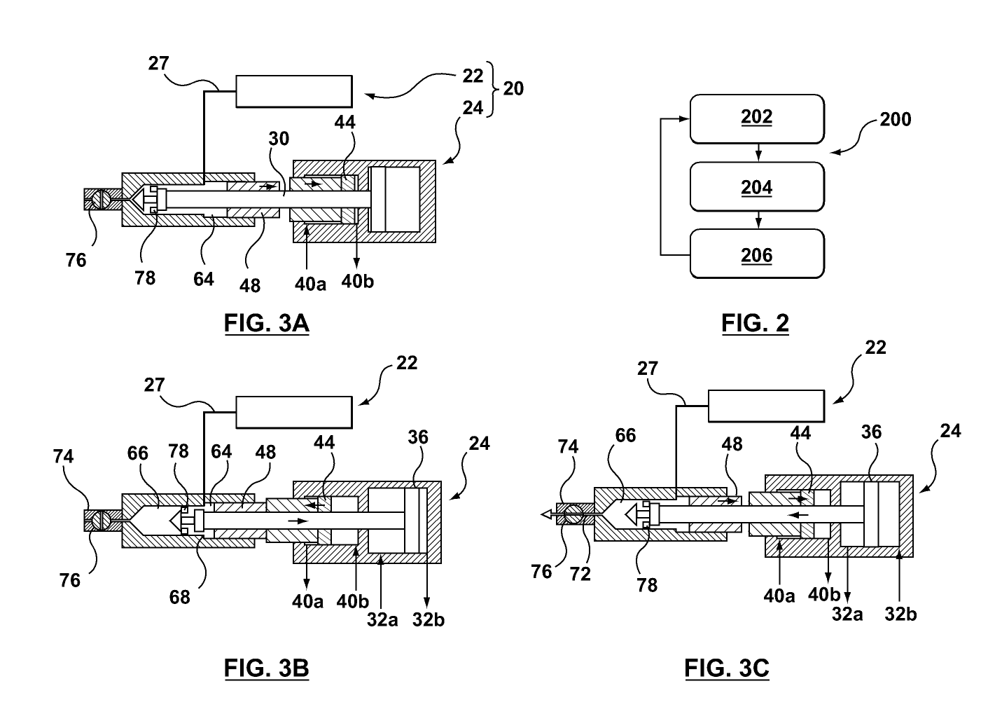

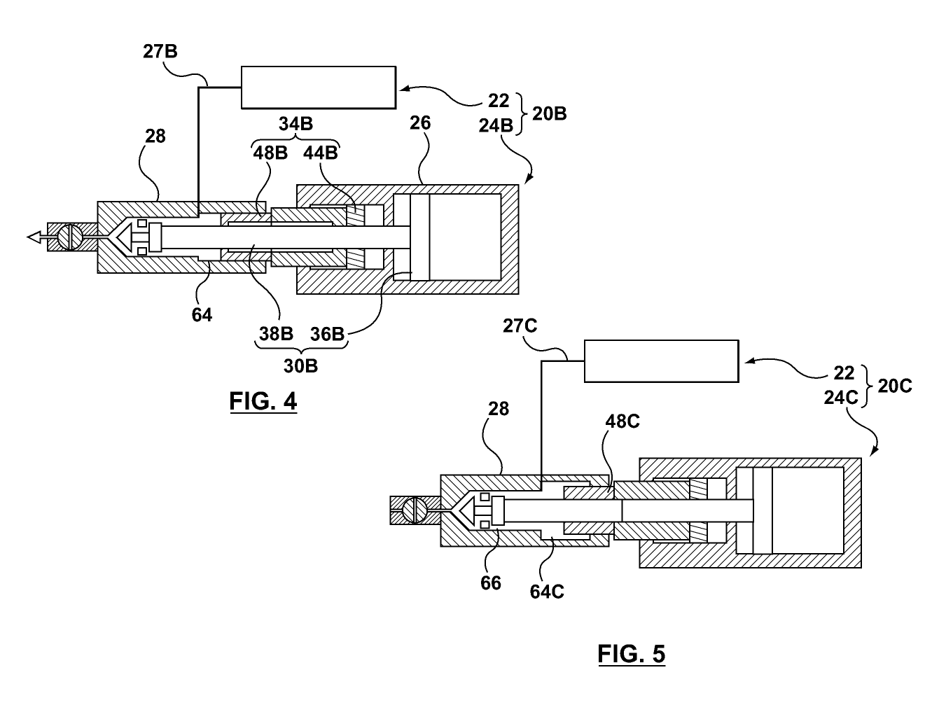

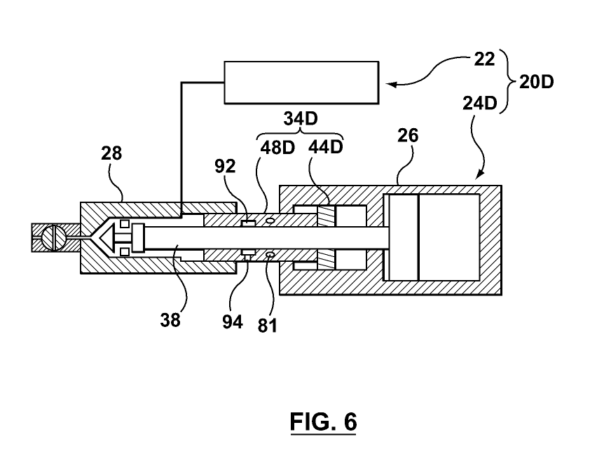

Referring now to FIG. 2 and FIGS. 3A-3C, the a method for operation of injection assembly 20 through an injection cycle 200 will be described in greater detail. Injection cycle 200 includes a buffer phase 202, a transfer phase 204 and an injection phase 206. In the example described, extruder unit 22 is running continuously plasticizing the melt throughout the entire injection cycle 200.

Referring now to FIG. 3A, injection assembly 20 is shown in its buffer phase 202. At the beginning of the buffer phase 202, injection piston assembly 30 is held in its forward position. Both the non-return valve 78 and the shut-off valve 76 are in their closed positions. The transfer piston 44 is retracted towards its rearward position by filling the rod side 40a with hydraulic fluid and draining the hydraulic fluid the cylinder side 40b (shown generally with the dotted arrows). As the melt produced in extruder unit 22 enters injection unit 24 from transfer channel 27, it flows back into the transfer pot 64, displacing the transfer plunger 48 rearwards. Once transfer pot 64 is filled, the injection cycle 200 moves to transfer phase 204.

Referring now to FIG. 3B, injection assembly 20 is shown in its transfer phase 204. The injection piston 36 moves towards its rearward position by filling the rod side 32a with hydraulic fluid and draining the hydraulic fluid the cylinder side 32b. The rearward motion of injection piston 36 opens the non-return valve 78. As the injection piston 36 is moving rearwards, the transfer piston 44 is moved towards its forward position by filling the cylinder side 40b with hydraulic fluid and draining the hydraulic fluid the rod side 40a. When the transfer piston 44 comes into contact with the transfer plunger 48, it translates the transfer plunger 48 forward so that the melt stored in the transfer pot 64 is forced into the injection pot 66. Given the relatively small constriction in diameter caused by land 68, there is a relatively low pressure drop between transfer pot 64 and injection pot 66. Injection unit 24 continues to receive new melt via transfer channel 27, with the new melt flowing directly into the injection pot 66. During the transfer phase 204, the shut-off valve 76 remains closed so that melt does not exit through the nozzle 74. Once the transfer phase 204 is complete, the injection cycle 200 moves to its injection phase 206.

Referring now to FIG. 3C, injection assembly 20 is shown in its injection phase 206. Shut-off valve 76 is opened. The injection piston 36 moves towards its forward position by filling the cylinder side 32b with hydraulic fluid and draining the hydraulic fluid the rod side 32a. The movement of injection piston 36 closes the non-return valve 78, thereby forcing the melt stored in injection pot 66 out through the outlet channel 72 of nozzle 74 towards the mold (not shown). Transfer piston 44 is retracted towards its rearward position by filling the cylinder side 40b with hydraulic fluid and draining the hydraulic fluid the rod side 40a. New melt from extruder unit 22 entering the injection unit 24 via transfer channel 27 displaces the transfer plunger 48 rearwards and flows back into the transfer pot 64. Once the injection stroke is complete, the shut-off valve 76 is closed, the injection phase 206 is complete, and a new injection cycle 200 can begin.

As mentioned previously, in the example described, extruder unit 22 is running continuously plasticizing the melt throughout the entire injection cycle 200 at a constant rate. However, it is contemplated that extruder unit 22 may vary its plasticizing rate throughout injection cycle 200 to optimize the fill rate and residency time of the melt within the injection unit 24. For example, extruder unit 22 may slow down and plasticize less melt during the transfer phase 204 and/or the injection phase 206. Alternatively, extruder unit 22 may stop plasticizing during the transfer phase 204 and/or the injection phase 206.

Referring now to FIG. 4, another example of an injection assembly 20B. Injection assembly 20B is similar to the previously-described example, and includes an extruder unit 22 and an injection unit 24B. Like the previously-described example, extruder unit 22 is a continuous extruder, but may also be adapted to run non-continuously.

The injection unit 24B includes the piston housing 26 and plunger housing 28 being separated from each other, also as described in greater detail above. Injection assembly 20 includes an injection piston assembly 30B and a transfer piston assembly 34B. As with the previously-described example, the transfer piston assembly 34B includes transfer piston 44B which is separated from the transfer plunger 48B so that the transfer piston 44B only motivates the transfer plunger 48B towards its forward position and not towards its rearward position. Instead, rearward motion of transfer plunger 48B is reliant upon melt pressure within transfer pot 64.

However, unlike the previously-described example, the injection piston assembly 30B also disconnects the injection piston 36B from the injection plunger 38B, thereby disconnecting the rearward movement of the injection piston 36B from the injection plunger 38B, and providing a period of lost motion in between. The forward movement of injection plunger 38B is motivated by the translation of injection piston 36B once the injection piston 36B translates forward sufficiently to make contact with injection plunger 38B, much as has been described above with reference to the transfer plunger 48B. However, retraction of the injection piston 36B does not translate the injection plunger 38B rearwards. Instead, the rearwards motion of injection plunger 38B is also provided by melt pressure, much as has been described above with reference to the transfer plunger 48B.

Referring now to FIG. 5, another example of an injection assembly 20C. Injection assembly 20C, the transfer channel 27C is located so that the melt is fed directly into a rear end of transfer pot 64C. A gap is provided between the sidewalls of transfer plunger 48C and the plunger housing 28 which permits the melt to flow forward and in front of the transfer plunger 48C. Alternatively, channels may be provided in the sidewalls of transfer plunger 48C (not shown) to permit the forward flow of the melt. As the melt coming from extruder unit 22 flows forward into the transfer pot 64C, it is subsequently transferred into the injection pot 66 (during the transfer phase 204) in a first-in, first-out arrangement (aka, “FIFO”).

Referring now to FIG. 6, another example of an injection assembly 20D. Injection assembly 20D includes an extruder unit 22 and an injection unit 24D. Within the injection unit 24D, the transfer piston 44D and the transfer plunger 48D of transfer piston assembly 34D are connected so as to move together. Transfer plunger 48D includes cooling channels 81 which are operable to circulate a cooling fluid. Cooling channels 81 are typically connected to a cooling fluid supply by flexible hoses on the exterior of injection unit 24 (neither shown). The cooling fluid in cooling channels 81 reduces undesired heat transfer from the melt within plunger housing 28 into the oil within piston housing 26.

Transfer plunger 48D also includes a leakage chamber 92 (being preferably annular-shaped in accordance with an example) defined on an interior surface of the transfer plunger 48D around injection plunger 38 which allows any melt that has seeped between the transfer plunger 48D and injection plunger 38 to be captured. The leaked melt that has been captured in leakage chamber 92 can be drained through a leakage port 94 which is defined in transfer plunger 48D and extends from leakage chamber 92 to the exterior of transfer plunger 48D. The leakage port 94 can be open allowing the leaked melt to exit the leakage chamber 92 via gravity, or can include a cap to permit periodic draining of leakage chamber 92.

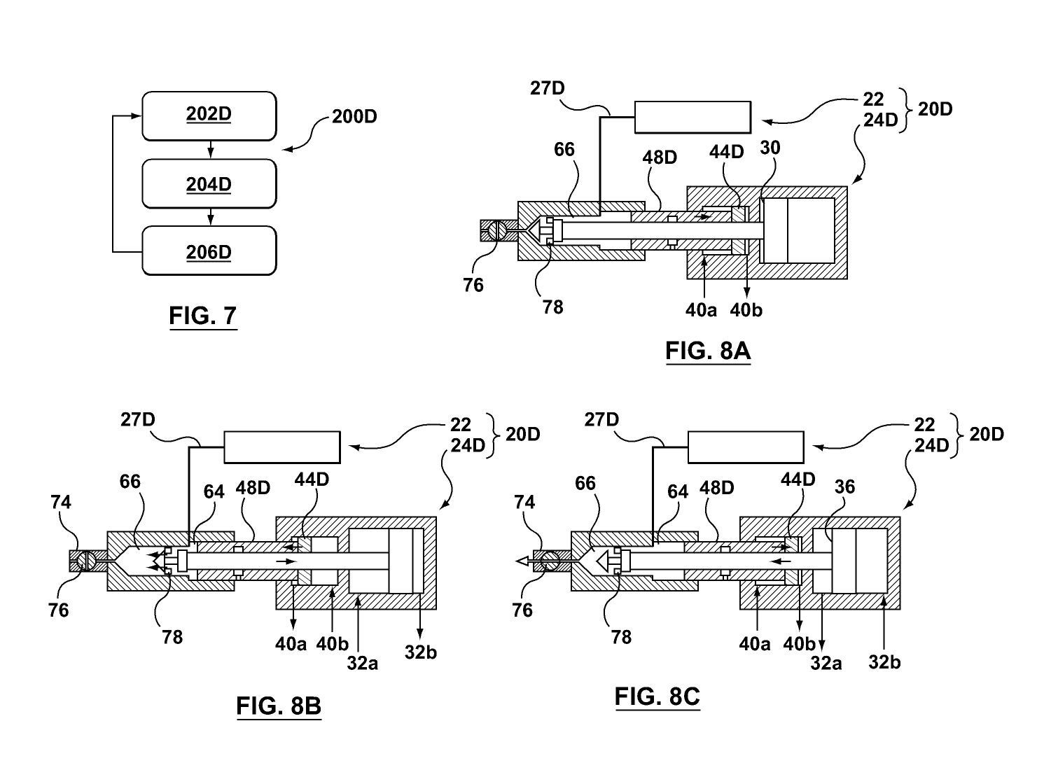

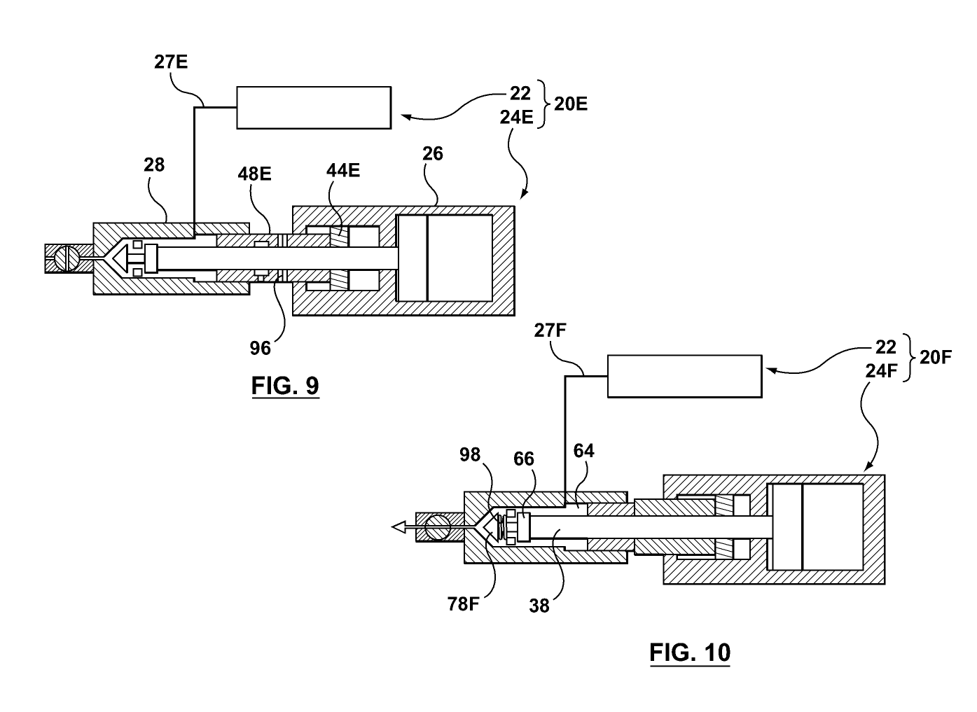

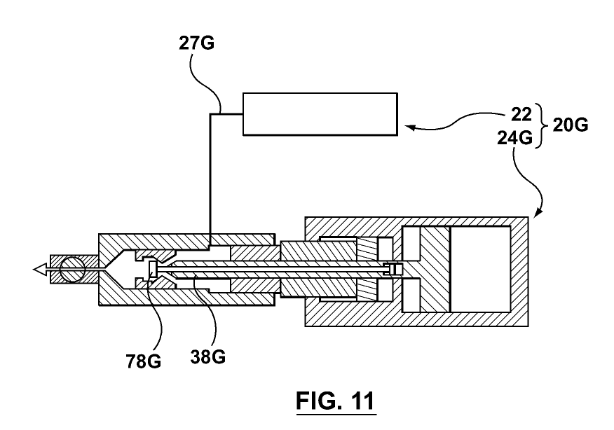

Referring now to FIG. 7, with additional reference to FIGS. 8A-8C, a method for the operation of injection assembly 20D through an injection cycle 200D will be described in greater detail. Injection cycle 200D includes a buffer phase 202D, a transfer phase 204D and an injection phase 206D. In the example described, extruder unit 22 is running continuously plasticizing the melt throughout the entire injection cycle 200D.

Referring now to FIG. 8A, injection assembly 20D is shown in its buffer phase 202. At the beginning of the buffer phase 202D, injection piston assembly 30 is held in its forward position. Both non-return valve 78 and shut-off valve 76 are closed. The transfer piston 44D is retracted towards its rearward position by filling the rod side 40a with hydraulic fluid and draining the hydraulic fluid the cylinder side 40b, thereby moving the transfer plunger 48D rearwards and creating space within transfer pot 64 to receive the melt from extruder unit 22 via transfer channel 27. Once transfer pot 64 is filled, the injection cycle 200D moves to transfer phase 204.

Referring now to FIG. 8B, injection assembly 20D is shown in its transfer phase 204D. The injection piston 36 moves towards its rearward position by filling the rod side 32a with hydraulic fluid and draining the hydraulic fluid the cylinder side 32b, thereby opening the non-return valve 78. As the injection piston 36 is moving rearwards, the transfer piston 44D is moved towards its forward position by filling the cylinder side 40b with hydraulic fluid and draining the hydraulic fluid the rod side 40a. As transfer piston 44D is connected to transfer plunger 48D, there is no lost motion, and transfer plunger 48D immediately begins to move forward, transferring melt from transfer pot 64 into the injection pot 66. Injection unit 24D continues to receive new melt via transfer channel 27, with the new melt flowing directly into the injection pot 66. During the transfer phase 204D, the shut-off valve 76 remains closed so that melt does not exit through the nozzle 74. Once the transfer phase 204D is complete, the injection cycle 200D moves to its injection phase 206D.

Referring now to FIG. 8C, injection assembly 20D is shown in its injection phase 206D. Shut-off valve 76 is opened. The injection piston 36 moves towards its forward position by filling the cylinder side 32b with hydraulic fluid and draining the hydraulic fluid the rod side 32a. The movement of injection piston 36 closes the non-return valve 78, forcing the melt stored in injection pot 66 out through the nozzle 74 towards the mold (not shown). Transfer piston 44D/transfer plunger 48D is retracted towards its rearward position by filling the rod side 40a with hydraulic fluid and draining the hydraulic fluid the cylinder side 40b, thereby creating space within transfer pot 64 to receive new melt. Once the injection stroke is complete, the shut-off valve 76 is closed, the injection phase 206D is complete, and a new injection cycle 200D may begin.

Referring now to FIG. 9, another example of an injection assembly 20E. Injection assembly 20E includes an extruder unit 22 and an injection unit 24E. Injection unit 24E includes a transfer plunger 48E that is operably connected to transfer piston 44E, much as was described above with reference to injection assembly 20D. However, instead of cooling channels 81, transfer plunger 48E includes an insulating barrier 96 to reduces undesired heat transfer from the melt within plunger housing 28 into the oil within piston housing 26.

Referring now to FIG. 10, another example of an injection assembly 20F. Injection assembly 20F includes an extruder unit 22 and an injection unit 24F. In injection unit 24F, the non-return valve located at the end of injection plunger 38 is a spring-actuated non-return valve 78F. Spring-actuated non-return valve 78F includes a spring 98 for urging the spring-actuated non-return valve 78F towards the closed position during injection and helps to prevent the melt from leaking from the injection pot 66 back into the transfer pot 64. The spring-actuated non-return valve 78F can be of the ball, ring or poppet types, as are known to those of skill in the art.

Referring now to FIG. 11, another example of an injection assembly 20G. Injection assembly 20G includes an extruder unit 22 and an injection unit 24F. In injection unit 24F, the non-return valve located at the end of injection plunger 38G an automatically actuated non-return valve 78G. The automatically actuated non-return valve 78G can be hydraulically, pneumatically or electrically actuated, and is operable to be open or closed independent of the movement of injection plunger 38G or the melt pressure being applied to the automatically actuated non-return valve 78G.

### Additional Description

The following clauses are offered as further description of the aspects of the present invention:

Clause (1): An injection unit (24), comprising: a transfer piston assembly (34); and an injection piston assembly (30) being positioned coaxial with the transfer piston assembly (34).

Clause (2): The injection unit (24) of claim 1, further comprising: a transfer pot (64) for receiving a melt from an extruder unit (22) via a transfer channel (27), the melt to be injected into a mold; an injection pot (66) being in communication with the transfer pot (64); wherein the transfer piston assembly (34) for transferring, in use, the melt from the transfer pot (64) to the injection pot (66); and the injection piston assembly (30) for transferring the melt from the injection pot (66) towards the mold.

Clause (3): The injection unit (24) of any preceding clause, wherein: the transfer pot (64) receives, in use, the melt from the extruder unit (22) while at the same time, at least in part, the injection piston assembly (30) transfers, in use, the melt out from the injection unit (24) towards the mold.

Clause (4): The injection unit (24) of any preceding clause, wherein: the injection unit (24) includes: a piston housing (26); and a plunger housing (28) being spaced apart from the piston housing (26); and the transfer piston assembly (34) includes: a transfer piston (44) located within the piston housing (26); and a transfer plunger (48) extending from the plunger housing (28) towards the piston housing (26).

Clause (5): The injection unit (24) of any preceding clause, wherein: the injection unit (24) includes: a piston housing (26); and a plunger housing (28) being spaced apart from the piston housing (26); and the injection piston assembly (30) includes: an injection piston (36) located within the piston housing (26); and an injection plunger (38) extending from the injection piston (36) into the plunger housing (28).

Clause (6): The injection unit (24) of any preceding clause, wherein: the injection unit (24) includes: a piston housing (26); and a plunger housing (28) being spaced apart from the piston housing (26); the transfer piston assembly (34) includes: a transfer piston (44) located within the piston housing (26); and a transfer plunger (48) extending from the plunger housing (28) towards the piston housing (26) and connected to the transfer piston (44); and wherein movement of the transfer piston (44) towards a forward position is operable to move the transfer plunger (48) forwards.

Clause (7): The injection unit (24) of any preceding clause, wherein: the injection unit (24) includes: a piston housing (26); and a plunger housing (28) being spaced apart from the piston housing (26); and the injection piston assembly (30) includes: an injection piston (36) located within the piston housing (26); and an injection plunger (38) being disconnected from the injection piston (36), and the injection plunger (38) extending from the plunger housing (28) towards the piston housing (26); and wherein movement of the injection piston (36) towards a forward position is operable to move the injection plunger (38) forwards.

Clause (8): The injection unit (24) of any preceding clause, wherein: the injection unit (24) is adapted to receive the melt from the extruder unit (22) proximate a rear end of the transfer pot (64) so that the melt is transferred from the transfer pot (64) to the injection pot (66) in a first-in, first-out arrangement.

Clause (9): The injection unit (24) of any preceding clause, wherein: the transfer piston assembly (34) includes: a transfer plunger (48) adapted for transferring the melt from the transfer pot (64) to the injection pot (66); and the injection piston assembly (30) includes: an injection plunger (38) adapted for transferring the melt from the injection pot (66) out from the injection unit (24) towards the mold, the injection piston assembly (30) extends through an aperture defined in the transfer piston assembly (34); and wherein the transfer piston assembly (34) includes a leakage chamber (92) defined on an interior surface of the transfer plunger (48), the leakage chamber (92) adapted to receive any of the melt which has seeped from the transfer pot (64) through a gap between the injection plunger (38) and the transfer plunger (48).

Clause (10): The injection unit (24) of any preceding clause, wherein: the transfer piston assembly (34) includes: a transfer piston (44); a transfer plunger (48) being coaxially aligned with the transfer piston (44).

Clause (11): The injection unit (24) of any preceding clause, wherein: the transfer piston assembly (34) includes: a transfer piston (44); a transfer plunger (48) being coaxially aligned with the transfer piston (44); and wherein each of the transfer piston (44) and the transfer plunger (48) include an aperture sized for receiving an injection plunger (38) so that the injection plunger (38) and the transfer plunger (48) can be actuated independently of each other.

Clause (12): An injection assembly (20), comprising the injection unit (24) of any preceding clause.

Clause (13): An injection molding system, comprising the injection unit (24) of any preceding clause.

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim. It is noted that the foregoing has outlined the non-limiting embodiments. Thus, although the description is made for particular non-limiting embodiments, the scope of the present invention is suitable and applicable to other arrangements and applications. Modifications to the non-limiting embodiments can be effected without departing from the scope of the independent claims. It is understood that the non-limiting embodiments are merely illustrative.

1. An injection unit (24), comprising:
a transfer piston assembly (34); and
an injection piston assembly (30) being positioned coaxial with the transfer piston assembly (34).

2. The injection unit (24) of claim 1, further comprising:
a transfer pot (64) for receiving a melt from an extruder unit (22) via a transfer channel (27), the melt to be injected into a mold;
an injection pot (66) being in communication with the transfer pot (64);
wherein the transfer piston assembly (34) for transferring, in use, the melt from the transfer pot (64) to the injection pot (66); and
the injection piston assembly (30) for transferring the melt from the injection pot (66) towards the mold.

3. The injection unit (24) of claim 2, wherein:
the transfer pot (64) receives, in use, the melt from the extruder unit (22) while at the same time, at least in part, the injection piston assembly (30) transfers, in use, the melt out from the injection unit (24) towards the mold.

4. The injection unit (24) of claim 2, wherein:
the injection unit (24) includes:
a piston housing (26); and
a plunger housing (28) being spaced apart from the piston housing (26); and
the transfer piston assembly (34) includes:
a transfer piston (44) located within the piston housing (26); and
a transfer plunger (48) extending from the plunger housing (28) towards the piston housing (26).

5. The injection unit (24) of claim 2, wherein:
the injection unit (24) includes:
a piston housing (26); and
a plunger housing (28) being spaced apart from the piston housing (26); and
the injection piston assembly (30) includes:
an injection piston (36) located within the piston housing (26); and
an injection plunger (38) extending from the injection piston (36) into the plunger housing (28).

6. The injection unit (24) of claim 2, wherein:
the injection unit (24) includes:
a piston housing (26); and
a plunger housing (28) being spaced apart from the piston housing (26);
the transfer piston assembly (34) includes:
a transfer piston (44) located within the piston housing (26); and
a transfer plunger (48) extending from the plunger housing (28) towards the piston housing (26) and connected to the transfer piston (44); and
wherein movement of the transfer piston (44) towards a forward position is operable to move the transfer plunger (48) forwards.

7. The injection unit (24) of claim 2, wherein:
the injection unit (24) includes:
a piston housing (26); and
a plunger housing (28) being spaced apart from the piston housing (26); and
the injection piston assembly (30) includes:
an injection piston (36) located within the piston housing (26); and
an injection plunger (38) being disconnected from the injection piston (36), and the injection plunger (38) extending from the plunger housing (28) towards the piston housing (26); and
wherein movement of the injection piston (36) towards a forward position is operable to move the injection plunger (38) forwards.

8. The injection unit (24) of claim 2, wherein:
the injection unit (24) is adapted to receive the melt from the extruder unit (22) proximate a rear end of the transfer pot (64) so that the melt is transferred from the transfer pot (64) to the injection pot (66) in a first-in, first-out arrangement.

9. The injection unit (24) of claim 2, wherein:
the transfer piston assembly (34) includes:
a transfer plunger (48) adapted for transferring the melt from the transfer pot (64) to the injection pot (66); and
the injection piston assembly (30) includes:
an injection plunger (38) adapted for transferring the melt from the injection pot (66) out from the injection unit (24) towards the mold, the injection piston assembly (30) extends through an aperture defined in the transfer piston assembly (34); and
wherein the transfer piston assembly (34) includes a leakage chamber (92) defined on an interior surface of the transfer plunger (48), the leakage chamber (92) adapted to receive any of the melt which has seeped from the transfer pot (64) through a gap between the injection plunger (38) and the transfer plunger (48).

10. The injection unit (24) of claim 2, wherein:
the transfer piston assembly (34) includes:
a transfer piston (44);
a transfer plunger (48) being coaxially aligned with the transfer piston (44).

11. The injection unit (24) of claim 2, wherein:
the transfer piston assembly (34) includes:
a transfer piston (44);
a transfer plunger (48) being coaxially aligned with the transfer piston (44); and
wherein each of the transfer piston (44) and the transfer plunger (48) include an aperture sized for receiving an injection plunger (38) so that the injection plunger (38) and the transfer plunger (48) can be actuated independently of each other.

12. and 13. (canceled)
